(19) United States
(12) Patent Application Publication
(10) Pub. No.: US 2024/0217756 A1
(43) Pub. Date: Jul. 4, 2024

(54) AUTOMATED MULTI-ARM ROBOTIC SYSTEM

(71) Applicant: Plus One Robotics, Inc., San Antonio, TX (US)

(72) Inventors: Paul Hvass, San Antonio, TX (US); Matthew Churchill, San Antonio, TX (US); Christopher Naville, San Antonio, TX (US)

(21) Appl. No.: 18/402,653

(22) Filed: Jan. 2, 2024

Related U.S. Application Data
(60) Provisional application No. 63/536,687, filed on Sep. 5, 2023.
(60) Provisional application No. 63/436,361, filed on Dec. 30, 2022.

(51) Int. Cl. B65G 47/31; B65G 47/32; B65G 47/90

(52) U.S. Cl. CPC B65G 47/31; B65G 47/32; B65G 47/907; B65G 2203/0233; B65G 2203/044

(57) ABSTRACT

A conveyance system includes an in-feed conveyor for conveying a high density flow of a plurality of parcels. The system further includes a first pick conveyor configured for being selectively activated and deactivated in order to space out the plurality of parcels and turn the high density flow into a low density flow of parcels. A second pick conveyor is in series with and downstream of the first pick conveyor. The system further includes a first place conveyor and a second place conveyor in series with and downstream of the first place conveyor. A first robot is configured for transferring parcels from the first pick conveyor to the first place conveyor. A second robot is configured for transferring parcels from the second pick conveyor to the second place conveyor. As such, robots each have their own dedicated workspace and do not interfere with each other.

### CROSS-REFERENCE TO RELATED APPLICATIONS

This application claims priority to U.S. Provisional Patent Application Ser. No. 63/436,361, filed Dec. 30, 2022, entitled “Automated Robotic Conveyance System,” the entire contents of which are incorporated herein by reference. This application further claims priority to U.S. Provisional Patent Application Ser. No. 63/536,687, filed Sep. 5, 2023, entitled “Systems and Methods for Serial Dual Arm Robotic Induction,” the entire contents of which are incorporated herein by reference.

### BACKGROUND

### Field of the Art

This disclosure relates to automated multi-arm robotic systems and methods for picking and/or placing parcels and efficiently dealing with exceptions.

### Discussion of the State of the Art

Robotics picking systems sometimes make use of dual arm systems to speed up the induction work flow. These systems typically include two robotic arms positioned across from each other with a supply chute positioned between them. An example of a dual robotic arm system is shown in FIG. 1, where the system 100 includes two robotic arms 102, 104 with a supply chute 106 positioned between them. In other words, there is one robotic arm on either side of the chute 106. The chute 106 is a single manual lane that may be split down the middle. The two robotic arms 102, 104 are picking parcels from the single chute 106 and placing them onto a sorter, which should theoretically improve throughput relative to single arm systems.

Dual arm induction systems, however, have some significant and intractable limitations which make them unsuitable for many applications despite improved theoretical throughput. For example, dual arm induction systems tend to have very poor placement accuracy for a variety of reasons. For example, it is difficult to configure a verification system due to physical and cost related constraints. In practice, the robotic arms 102, 104 tend to miss the sorter and the system 100 is not configured to verify the quality of the placements. Another disadvantage of these current systems is the failure to manage exceptions. This limitation is also structural and inherently caused by the manner in which dual arm induction systems are laid out.

Currently, no available robotic picking systems offer the improved theoretical throughput of dual arm induction systems with improved accuracy including but not limited to improved singulation accuracy, and with an effective exceptions handling system.

### SUMMARY

An automated robotic conveyance system in accordance with the present invention includes two or more pick area conveyor belts that operate in series with each other and an exceptions handling area at the end of the pick area so that exceptions do not have to be handled by the manipulators at all. The system further includes two or more manipulators that are configured to pick items from the pick area and place the items in the place area. Each one of the manipulators has an associated dedicated pick area and place area so that the manipulators are able to work independently of each other. The system is configured to identify exceptions and instruct the manipulators to avoid handling the exceptions. Still further, the system is configured to verify placement accuracy in the place area. A benefit of the serial flow layout disclosed herein is the ability to handle larger items in a given amount of footprint. With the prior art parallel flow systems having divided lanes, the lanes/pick zones are smaller by necessity, which limits the size of the largest parcels that can be handled by prior art systems.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a conventional system for dual arm induction.

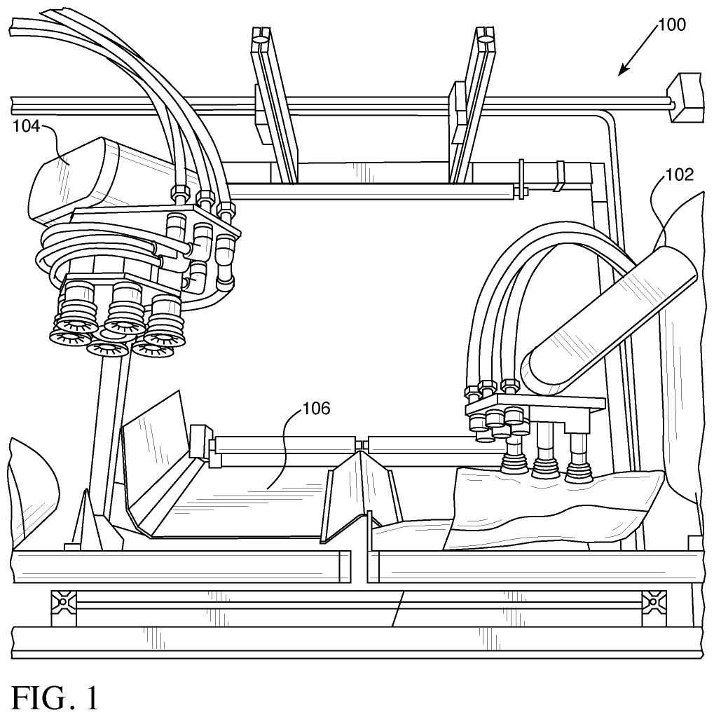

FIG. 2 illustrates a system for serial dual arm robotic induction in accordance with an exemplary embodiment of the invention.

FIG. 3 illustrates an automated robotic conveyance system having a plurality of robotic arms and a plurality of supply chutes, in accordance with one embodiment of the present invention.

FIG. 4 illustrates an automated robotic conveyance system having two robotic arms and a single supply chute, in accordance with one embodiment of the present invention.

FIG. 5 illustrates a system for serial dual arm robotic induction in accordance with an exemplary embodiment of the invention.

FIG. 6 illustrates a control system for use in serial dual arm robotic induction in accordance with an exemplary embodiment of the present invention.

### DETAILED DESCRIPTION

An automated robotic conveyance system in accordance with the present invention includes a plurality of pick area conveyor belts that operate in series with each other and an exceptions handling area at the end of the pick area so that exceptions do not have to be handled by the manipulators at all. The system further includes two or more manipulators that are configured to pick items from the pick area and place the items in the place area. The system is configured to identify exceptions and instruct the manipulators to avoid handling the exceptions. Still further, the system is configured to verify placement accuracy in the place area.

The invention is described by reference to various elements herein. It should be noted, however, that although the various elements of the inventive apparatus are described separately below, the elements need not necessarily be separate. The various embodiments may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Overview

The system of the present invention is an automated robotic conveyance system that includes serialized conveyor belts in the pick and place areas and an exceptions handling area at the end of the pick area conveyor belts. The system is configured for verifying placement of items in the place area in order to minimize damage to, and downtime of, the sorter.

### Conceptual Architecture

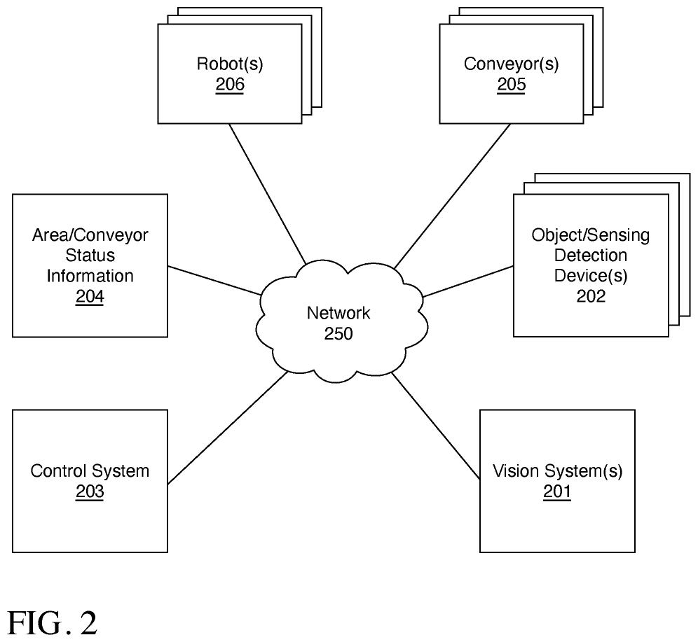

FIG. 2 illustrates an exemplary embodiment of a serial dual arm robotic induction system according to one embodiment. The system includes vision system 201, object sensing/detection device 202, robots 206, conveyors 205, conveyor status information 204, control system 203, and a network 250 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

As a general overview, robot(s) 206 operate to pick objects from one conveyor 205 and move the objects to another conveyor 205. Control system 203 coordinates the movement of conveyors 205 to move objects through the system towards a downstream induction destination. The control system 203 may use at least one of area/conveyor status information 204, input from vision system(s) 201, and input from object sensing/detection device(s) 202 in determining appropriate controls for conveyors 205.

Robot(s) 206 may generally comprise a robot or robotic system capable of moving objects from one location to another. Robot(s) 206 may comprise robotic arms. Robot(s) 206 may be positioned relative to conveyors 205 such that objects can be moved from one conveyor to another.

Conveyor(s) 205 may generally comprise any conveying system capable of moving objects. Conveyor(s) 205 may comprise a belt conveyor, roller conveyor, chain conveyor, screw conveyor, track or rail conveyor, slat conveyor, motorized conveyor, vertical conveyor, horizontal conveyor, incline or decline conveyor, and combinations thereof. Conveyor(s) 205 may comprise variable speed control and/or direction control (e.g. forward/reverse control).

Vision system(s) 201 are generally operable to process data of an area to identify objects within the area. Vision system(s) 201 may process image and/or depth data of the area. Vision system(s) 201 may identify objects as being pickable objects (i.e. something the robot 206 can/should pick and move) and/or rejection/exception objects (i.e. something the robot 206 cannot/should not pick and move or something the vision system 201 is unsure about). Vision system 201 may include a plurality of camera for obtaining images at various locations throughout the conveyance system.

Object sensing/detection device(s) 202 are generally operable to detect the presence of objects and when an objects move from one location to another. For example, light beam or light array based devices may be positioned such that an object passing by the device is detected thereby providing the system with information about the location of objects and when objects are passing through certain locations such as from one conveyor 205 to the next.

Conveyor status information 204 generally comprises status information for at least one component of the automated induction system. Conveyor status information 204 may comprise status information for at least one of each conveyor in the automated induction system and each robot in the automated induction system. Conveyor status information 204 may comprise indexing information (e.g. index values) indicating the status of the one or more system components.

Control system 203 is generally operable to determine control instructions and/or generate control signals for one or more components of the automated induction system. Control system 203 may obtain status information 204 and analyze the status information 204 to determine suitable controls for efficiently moving objects within the automated induction system. Control system 203 may obtain information from the different system components (e.g. vision system 201, conveyor 205, robot 206, etc.) and determine corresponding status information based on the obtained system component information. The determined status information may be stored, updated and/or accessed as needed in order to determine appropriate control and timing of control for one or more conveyors 205.

Control system 203 may be embodied as one or more user device(s) which may include, generally, a computer or computing device including functionality for communicating (e.g., remotely) over a network 250. Data may be collected from user devices, and data requests may be initiated from each user device. User device(s) may be a server, a desktop computer, a laptop computer, personal digital assistant (PDA), an in- or out-of-car navigation system, a smart phone or other cellular or mobile phone, or mobile gaming device, among other suitable computing devices. User devices may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 250.

In particular embodiments, each user device may be an electronic device including hardware, software, or embedded logic components or a combination of two or more such components and capable of carrying out the appropriate functions implemented or supported by the user device. For example and without limitation, a user device may be a desktop computer system, a notebook computer system, a netbook computer system, a handheld electronic device, or a mobile telephone. The present disclosure contemplates any user device. A user device may enable a network user at the user device to access network 250. A user device may enable its user to communicate with other users at other user devices.

The user device may also include an application that is loaded onto the user device. The application obtains data from the network 250 and displays it to the user within the application interface.

Network cloud 250 generally represents a network or collection of networks (such as the Internet or a corporate intranet, or a combination of both) over which the various components illustrated in FIG. 2 (including other components that may be necessary to execute the system described herein, as would be readily understood to a person of ordinary skill in the art) may communicate with each other. In particular embodiments, network 250 is an intranet, an extranet, a virtual private network (VPN), a local area network (LAN), a wireless LAN (WLAN), a wide area network (WAN), a metropolitan area network (MAN), a portion of the Internet, or another network 250 or a combination of two or more such networks 250. One or more links connect the systems and databases described herein to the network 250. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 250, and any suitable link for connecting the various systems and databases described herein.

The system may also contain other subsystems and databases, which are not illustrated in FIG. 2, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

### Apparatus

The present invention is directed to a system having two or more robotic arms configured for taking on or inducting from a single in-feed conveyor. The system is better, faster, cheaper and simpler than previous systems and takes up less space than previous systems. The smaller footprint of the present invention allows for more space for manual induction and/or reverting to manual induction.

The present system is configured for high speed replenishment of the pick area and passive exceptions handling. Generally, in accordance with an embodiment of the invention, the pick conveyors stop moving while the robots are picking from a pick area. The robots then pick good or available products from the stationary conveyor. The exceptions are indexed out of the pick area while concurrently replenishing new product into the pick area. The exceptions area is located at the end of the pick area. Exceptions don't have to be touched by the robotic arm(s). In one example, the system (e.g., using artificial intelligence) determines that the package/parcel should not be handled by the robot. While the exceptions are being disposed of without robot intervention, new parcels/parcels are being fed into the system at the same time.

An “exception” is a package or parcel that is difficult or impossible for the robotic arms to pick up. Additionally, exceptions can also be items that can be handled by the robot but not the sorter. Examples include oversized, undersized, cylindrical, high aspect ratio, etc. Exceptions typically require human intervention. Previous systems typically require the system to shut down to allow for human intervention. A benefit of the present invention, as would be clear based on the provided descriptions, is that the system passively addresses foreign objects—i.e. spilled parcels, zip ties, trash, etc. that would lead to a jam or accumulation in the pick area if there is no path to clear them.

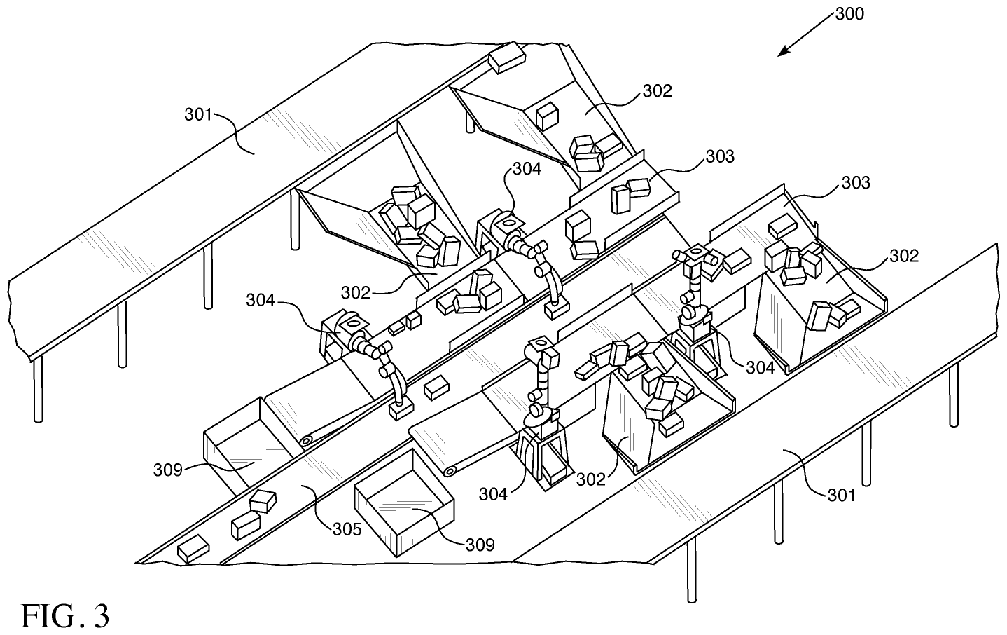

FIG. 3 depicts an automated robotic conveyance system 300 that includes bulk areas 301, buffer areas 302, pick areas 303, robotic arms 304, a place area 305, and exceptions areas 309. The bulk area 301 is where the bulk product supply comes from. Diverter paddles in the bulk area 301 divert the parcels into the buffer areas 302. The buffer areas 302 may include a conveyor and may have a large vertical capacity that can receive a large volume of product and meter it out into the pick areas 303. The buffer areas 302 are advantageous for supporting high throughputs of product through, for example, storing and metering out product from an intermittent and unpredictable supply. As such, the buffer areas 302 are configured for holding a high density supply of product. There is a velocity differential between the buffer conveyor and the pick area conveyor so that the high density supply of product in the buffer area 302 can be turned into a low density supply in the pick area 303. The reduced density of parcels in the pick area 303 is conducive to robotic handling of the parcels.

The system 300 includes two pick areas 303, where one pick area 303 is positioned along each side of the place area 305. Each one of the pick areas 303 includes a series of conveyor belts that are programmed to turn off and on, depending on how much product is present on the conveyor belt. Product flows from one conveyor belt to the next conveyor belt in the series until it is either picked up by the robotic arms 304 and moved to the place area 305, or it reaches the end of the pick area 303 and flows into the exceptions area 309. Product that gets deposited into the exceptions area 309 is easily accessible for human intervention.

Each one of the robotic arms 304 is associated with one buffer area 302. In other examples, two or more robotic arms are used to unload one buffer area. Further, the invention is not limited to single arm robots such as those depicted in FIG. 3. Other manipulators may be used to pick and place the parcels. For example, the manipulator may be a human, a single robot having two arms, or the like. Any kind of manipulator may be used, so long as it is able to move product from the pick area 303 to the place area 305.

Although the robotic arms 304 are depicted as being mounted to, or resting on, the floor, it will be readily appreciated by one of ordinary skill in the art that the robotic arms 304 may alternatively be mounted to a wall, ceiling, overhead frame, or the like. In one exemplary embodiment, the robotic arms 304 are attached to a frame and positioned above the conveyors. The system 300 is not limited to the robotic arms 304 standing on the ground alongside the conveyors.

Product or parcels that are exceptions are identified by the vision system of the automated system 300. The robotic arms 304 are instructed to avoid items that are identified as exceptions. As such, the items identified as exceptions simply remain on the conveyor belts in the pick area 303 until the end of the conveyor belt series, at which point the exceptions are deposited into the exceptions area 309.

The system 300 may further include sensors operatively coupled to one or more of the conveyors. The sensors are configured for detecting whether a part is present. Such sensors may be operatively coupled to the pick conveyors and/or the place conveyors and signals from the sensors may be processed to determine whether a part is present and/or to confirm placement. The sensors may be line sensors, multi beam sensors, or the like, or a combination thereof.

Rather than being perpendicular to the sorter and parallel to each other, the fully separated streams on the pick side are fed in series. This arrangement allows for a flow-through exceptions path with minimal impact on system throughput.

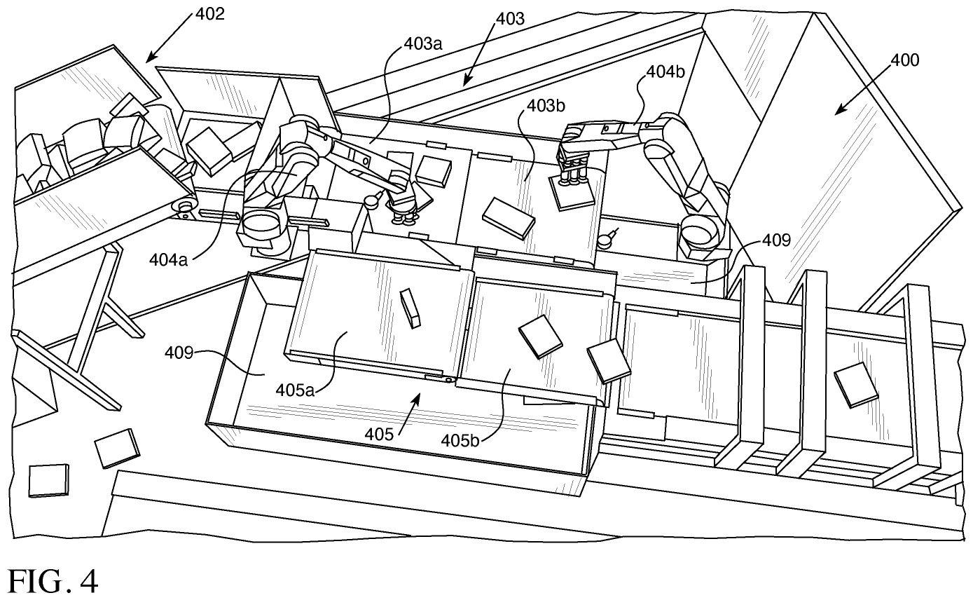

Another example of an automated robotic conveyance system 400 is shown in FIG. 4. The system 400 includes a bulk area (not shown), a buffer area 402, a pick area 403, robotic arms 404, a place area 405, and exceptions areas 409. The buffer area 402 includes a conveyor and may have a large vertical capacity that can receive a large volume of product and meter it out into the pick area 403. The buffer area 402 is advantageous for supporting high throughputs of product. As such, the buffer area 402 is configured for holding a high density supply of product. There is a velocity differential between the buffer conveyor and the pick area conveyor so that the high density supply of product in the buffer area 402 can be turned into a low density supply in the pick area 403. The lower density of parcels in the pick area 403 is conducive to robotic handling of the parcels.

The pick area 403 is positioned alongside the place area 405. The pick area 403 includes two conveyor belts 403a, 403b that operate in series and are programmed to turn off and on, depending on whether product is present on the conveyor belt. Product flows from the first pick conveyor 403a to the next pick conveyor 403b in the series until it is either picked up by the robotic arms 404 and moved to the place area 405, or it reaches the end of the pick area 403 and flows into the exceptions area 409. Product that gets deposited into the exceptions area 409 is routed outside of the robotic workcell. In one, non-limiting example, the exceptions area 409 may include a chute that leads below a mezzanine for potential human intervention.

In this example, two robotic arms 404 are simultaneously working on a single buffer area 402. It should be noted that the invention is not limited to single arm robots. Rather, the manipulators may be dual arm robots, humans, or the like. One advantage of the arrangement shown in FIG. 4 is that the manipulators 404 may work together to manipulate very large or very heavy objects.

Although the robotic arms 404 are depicted as being mounted to, or resting on, the floor, it will be readily appreciated by one of ordinary skill in the art that the robotic arms 404 may alternatively be mounted to a wall, ceiling, overhead frame, or the like. In one exemplary embodiment, the robotic arms 404 are attached to a frame and positioned above the conveyors. The system 400 is not limited to the robotic arms 404 standing on the ground alongside the conveyors.

As the first robotic arm 404a is removing parcels from the first pick area conveyor belt 403a, the first pick area conveyor belt 403a is quickly replenished from the buffer area 402. As the second robotic arm 404b is removing parcels from the second pick area conveyor belt 403b and the second conveyor belt 403b becomes empty, both conveyor belts 403a, 403b turn on and are replenished while the first robot 404a is moving product to the place area 405. This methodology allows for extremely fast replenishment of both pick area conveyor belts 403a, 403b.

The place area conveyor belts 405a, 405b being alongside the pick area conveyor belts 403a, 403b, respectively, allows for the place area conveyor belts 405a, 405b to be independently turned off while product is placed thereupon and an image of the product on the place area conveyor belt 405a, 405b is obtained. The placement of the product on the place area conveyor belt 405a, 405b is verified before the conveyor belts 405a, 405b are turned on.

Placement verification is accomplished by taking an image of each item and using the image to confirm that the item is singulated, properly oriented, and properly sized before the item goes to the sorter (at the end of the place area conveyor belts 405). Because placement verification takes place during the pick and place process, rather than separately, the system 400 is configured for high throughput with high quality. In one example, an image is taken of the item(s) as soon as it is placed in the place area 405. The image is processed to confirm placement accuracy. If the item is not properly placed (i.e. size oriented or singulated, etc.), the system 400 is configured to instruct the manipulators 404 to correct the placement of the item.

Placement verification is advantageous to ensure that items that are being pushed into the sorter are not going to cause rework and downtime later. Improper placement of a product causes a sorter to shut down in many cases. It also can cause physical damage to the sorter.

When the feed starts, the downstream robot 404b gets priority. Product is fed through the system until the last robot 404b in the chain receives product. Once the last robot 404b receives product, it starts working and then the next robot upstream 404a can receive product and start working.

The system 400 may further include sensors operatively coupled to one or more of the conveyors. The sensors are configured for detecting whether a part is present. Such sensors may be operatively coupled to the pick conveyors and/or the place conveyors and signals from the sensors may be processed to determine whether a part is present and/or to confirm placement. The sensors may be line sensors, multi beam sensors, or the like, or a combination thereof.

Alternatively or additionally, the system 400 may include a “low prime” sensor, which is the upstream sensor on the conveyor. A variety of sensors may be used herein, as would be apparent to a person of ordinary skill in the art without departing from the scope of the invention, including proximity sensors, imaging sensors, depth-sensors or 3D sensors, transducers, piezo-electric sensors, etc. In another example, the system 400 may include a “parts present” sensor, which determines whether parts are available in the pick area. Both of those sensors must be satisfied on the downstream robot 404b before the conveyor belt is stopped for the upstream robot 404a. In other words, if the second robot 404b is satisfied (i.e., parts are present in the pick area 403b and there are objects/parts in the conveyor belt), then the conveyor belts 403a, 403b may be stopped to give the robotic arms 404a, 404b time to move the product from the pick side conveyor belts 403a, 403b to the place side conveyor belts 405a, 405b, respectively. The conveyor belts 403a, 403b do not stop until the second robotic arm 404b is satisfied. In examples where there are more than two robotic arms, the pick area conveyor belts do not stop until the downstream robotic arm is satisfied.

The downstream robotic arm gets priority since it is farthest away from the supply. In other words, satisfying the downstream robotic arm (i.e., giving it product to move) is the most important priority. The upstream robotic arm(s) are closest to the supply and can thus receive supply fairly quickly and almost instantly. Making sure that the downstream robotic arm stays busy ensures that the most product is moved in the shortest possible amount of time.

In one embodiment, the invention is comprised of multiple conveyor belts in series. This configuration enables the upstream robot and the downstream robot to work at their own pace, wherein the pace will primarily depend on the number of items/parts in the pick area. For example, if there are four items in the downstream robot's pick area, then the downstream conveyor belt may be stopped while the downstream robot works to place the four items while the upstream robot continues to work and/or receive items in the upstream pick area. In exemplary embodiments, high rates may be achieved with a decoupled supply feed.

The present conveyance system allows for dedicated streams for the two robotic arms in the same space, while also allowing for a flow-through exceptions path.

One advantage of the current system is that there is physical separation between the robotic arms, thus minimizing possible interaction or interference between the robotic arms and optimizing the motion of the robotic arms.

Another advantage of the current system is that the current system may take up less space than previous systems and does not block manual access. The current system may have a smaller footprint than previous systems.

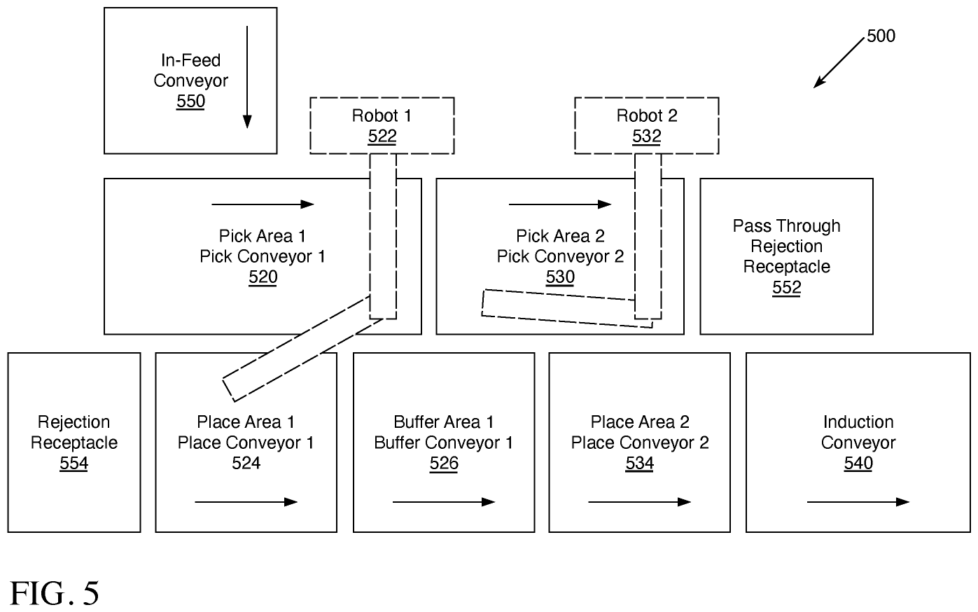

FIG. 5 illustrates an exemplary embodiment of an automated serial dual arm robotic induction system 500 according to one embodiment. The system includes in-feed conveyor 550, a first pick conveyor 520, a second pick conveyor 530, a first robot 522, a second robot 532, a first place conveyor 524, buffer conveyor 526, a second place conveyor 534, induction conveyor 540, pass through rejection receptacle 552, and rejection receptacle 554. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks via alternate arrangements or configurations without departing from the scope of the invention.

In-feed conveyor 550 is operable to provide objects (e.g. parcels, boxes, etc.) for picking/sorting by the automated induction system. In-feed conveyor 550 may comprise a belt conveyor, roller conveyor, chain conveyor, screw conveyor, track or rail conveyor, slat conveyor, motorized conveyor, vertical conveyor, horizontal conveyor, incline or decline conveyor, and combinations thereof. The conveyor may comprise variable speed control and/or direction control (e.g. forward/reverse control).

The first pick conveyor 520 is operable to receive objects and move objects along a first pick area. The first pick conveyor 520 may receive objects from in-feed conveyor 550 and move objects towards the second pick conveyor 530. The first pick conveyor 520 is operable to move at a speed greater than in-feed conveyor 550 thereby serving to increase the spacing between objects as they move from in-feed conveyor 550 onto the first pick conveyor 520 thereby allowing for improved capabilities in identifying and picking of distinct objects by robots. The first pick conveyor 520 may move objects within a first pick area associated with the first robot 522. The first pick conveyor 520 may comprise a belt conveyor, roller conveyor, chain conveyor, screw conveyor, track or rail conveyor, slat conveyor, motorized conveyor, vertical conveyor, horizontal conveyor, incline or decline conveyor, and combinations thereof. The first pick conveyor 520 may comprise variable speed control and/or direction control (e.g. forward/reverse control).

The second pick conveyor 530 is operable to receive objects and move objects along a second pick area. The second pick conveyor 530 may receive objects from the first pick conveyor 520 and move objects towards the pass through rejection station (e.g. pass through rejection receptacle 552, conveyor or the like). The second pick conveyor 530 may comprise a belt conveyor, roller conveyor, chain conveyor, screw conveyor, track or rail conveyor, slat conveyor, motorized conveyor, vertical conveyor, horizontal conveyor, incline or decline conveyor, and combinations thereof. The second pick conveyor 530 may comprise variable speed control and/or direction control (e.g. forward/reverse control).

The first robot 522 may comprise a robotic arm or other robotic system operable to move objects from a first location to a second location (e.g. from the first pick conveyor 520 to the first place conveyor 524). In one aspect, the first robot 522 may pick objects from a first pick area associated with the first pick conveyor 520 and move the objects to a first place area associated with the first place conveyor 524. The first robot 522 may operate based on instructions from at least one of a vision system (e.g. vision system 201) and a control system (e.g. control system 203).

The second robot 532 may comprise a robotic arm or other robotic system operable to move objects from a first location to a second location (e.g. from the second pick conveyor 530 to the second place conveyor 534). In one aspect, the second robot 532 may pick objects from a second pick area associated with the second pick conveyor 530 and move the objects to the second place area associated with the second place conveyor 534. The second robot 532 may operate based on instructions from at least one of a vision system (e.g. vision system 201) and a control system (e.g. control system 203). In one aspect, the second robot 532 may be considered as the prioritized robot in the overall system such that the second robot 532 consistently has an opportunity to continue picking objects from the second pick conveyor 530 rather than regularly having to wait for parcels to arrive within the second pick area in order to execute picking operations. This allows for a higher processing rate of objects through the overall system as more simultaneous picking can occur with both robots 522 and 532 operating simultaneously rather than one robot waiting for pickable objects to arrive or waiting for the other robot to complete an action as may occur if robot 522 is prioritized or in conventional parallel picking configurations.

The first place conveyor 524 is operable to receive objects and move objects along a first place area. The first place conveyor 524 may receive objects placed by the first robot 522, such as those picked and moved from the first pick conveyor 520. Upon successful placement of an object on the first place conveyor 524, the first place conveyor 524 may move the object to buffer conveyor 526 thereby freeing up space for another object to be placed on the first place conveyor 524. The first place conveyor 524 may receive objects from buffer conveyor 526, such as when an exception or rejection object has been identified on the place side of the system and such object needs to be moved to rejection receptacle 554. As such, the first place conveyor 524, and the buffer conveyor 526 may be at the same level. That is, the first place conveyor 524 and the buffer conveyor 526 may be collinear. The first place conveyor 524 may comprise a belt conveyor, roller conveyor, chain conveyor, screw conveyor, track or rail conveyor, slat conveyor, motorized conveyor, vertical conveyor, horizontal conveyor, incline or decline conveyor, and combinations thereof. The first place conveyor 524 may comprise variable speed control and/or direction control (e.g. forward/reverse control).

The buffer conveyor 526 is operable to receive objects and move objects along a buffer area. Buffer conveyor 526 may receive objects from the first place conveyor 524. Buffer conveyor 526 may hold objects for a suitable time prior to moving objects downstream to the second place conveyor 534. Buffer conveyor 526 serves to allow objects to moved from an adjacent conveyor thereby freeing up space for further object placements until a suitable time when conveyors can be activated to pass objects through to induction conveyor 540. Although only one buffer conveyor 526 is depicted, a plurality of buffer conveyors may be employed depending on various factors such as space limitations and optimal number of buffers necessary to minimize downtime of robot movements due to waiting for an open space to place a picked object. Buffer conveyor 526 may comprise a belt conveyor, roller conveyor, chain conveyor, screw conveyor, track or rail conveyor, slat conveyor, motorized conveyor, vertical conveyor, horizontal conveyor, incline or decline conveyor, and combinations thereof. The buffer conveyor 526 may comprise variable speed control and/or direction control (e.g. forward/reverse control).

The second place conveyor 534 is operable to receive objects and move objects along a second place area. The second place conveyor 534 may receive objects placed by the second robot 532, such as those picked and moved from the second pick conveyor 530. Upon successful placement of an object on the second place conveyor 534, the second place conveyor 534 may move the object downstream to induction conveyor 540. The second place conveyor 534 may receive objects from buffer conveyor 526 and, when appropriate, continue moving objects along to induction conveyor 540. The second place conveyor 534 may comprise a belt conveyor, roller conveyor, chain conveyor, screw conveyor, track or rail conveyor, slat conveyor, motorized conveyor, vertical conveyor, horizontal conveyor, incline or decline conveyor, and combinations thereof. The second place conveyor 534 may comprise variable speed control and/or direction control (e.g. forward/reverse control).

Placement verification is accomplished by taking an image of each item and using the image to confirm that the item is singulated, properly oriented, and properly sized before the item goes to the sorter (at the end of the place area conveyor belts 524, 534). Because placement verification takes place during the pick and place process, rather than separately, the system 500 is configured for high throughput with high quality. In one example, an image is taken of the item(s) as soon as it is placed in the place area. The image is processed to confirm placement accuracy. If the item is not properly placed (i.e. size oriented or singulated, etc.), the system 500 is configured to instruct the manipulators 522, 532 to correct the placement of the item.

Placement verification is advantageous to ensure that items that are being pushed into the sorter are not going to cause rework and downtime later. Improper placement of a product causes a sorter to shut down in many cases. It also can cause physical damage to the sorter.

Induction conveyor 540 is operable to receive objects from the second place conveyor 534 and move objects downstream for object induction. Induction conveyor 540 may comprise a belt conveyor, roller conveyor, chain conveyor, screw conveyor, track or rail conveyor, slat conveyor, motorized conveyor, vertical conveyor, horizontal conveyor, incline or decline conveyor, and combinations thereof. The induction conveyor 540 may comprise variable speed control and/or direction control (e.g. forward/reverse control).

The first rejection receptacle 552 is operable to receive exception or rejection objects passing through the system on the pick side (i.e. the pick conveyors 520, 530). Exception or rejection objects may generally comprise objects which require further handling or intervention. Such objects may comprise, but are not limited to, at least one of damaged objects, objects which a vision system was uncertain how to handle, objects which a robot was unable to pick or handle with sufficient confidence, and objects which are deemed improper for induction. The first pass through rejection receptacle 552 may comprise a component(s) other than a receptacle such as an additional conveying system, chute, table, surface, or other component suitable for receiving objects.

The second rejection receptacle 554 is operable to receive exception or rejection objects passing through the system on the place side (i.e. the place conveyors 524, 534 and buffer conveyor 526). In one aspect, the second rejection receptacle 554 may receive objects rejected downstream (e.g. from induction conveyor 540 or elsewhere) wherein the rejected objects can be passed back upstream through the place and buffer conveyors 524, 534, 526 and ultimately arriving at rejection receptacle 554. As such, the place conveyors 524, 534 and the buffer conveyor 526 may be collinear (i.e., positioned at the same elevation as each other). Rejection receptacle 554 may comprise components other than a receptacle such as an additional conveying system, chute, table, surface, or other component suitable for receiving objects.

It is noted that the arrows in FIG. 5 are an exemplary embodiment indicative of what may be typical conveyor movement and object flow during standard induction (e.g. objects being successfully placed and passed on without being rejected or returned from the downstream induction conveyor). However, each conveyor may be operated independently or in combination to reverse the movement direction and direct objects in a manner other than that depicted by the arrows. Although not depicted, one or more conveyors may be associated with a vision system for detecting objects located within each corresponding area. Although not depicted, one or more conveyors may be associated with other object sensing/detection device(s) for detecting objects located within each corresponding area. For example, light beam or light array devices may be positioned such that an object passing by the device is detected thereby providing the system with information about the location of objects and when objects are passing through certain locations such as from one conveyor to the next.

This arrangement in FIG. 5 is merely exemplary and the components may be repositioned, rearranged and have their orientation modified without departing from the scope of the invention. For example, the in-feed conveyor 550 could be arranged in line with or at an angle reactive to the pick conveyors 520, 530. As another example, the in-feed conveyor 550 could be positioned on the right side of FIG. 5 where the pass through receptacle 552 is located and the pass through receptacle 522 moved to the left side of the first pick conveyor 520 without departing from the scope of the invention. Other modifications could be made as would be apparent to one of ordinary skill in the art without departing from the scope of the invention. As would be apparent to one of ordinary skill in the art, a change in the arrangement or orientation of components would be accompanied by a corresponding change in the control logic and decision making logic. Such would fall within the scope of the invention and would generally follow the same principle of moving objects downstream, i.e. from in-feed conveyor 550 towards the induction conveyor 540 which may comprise reversing or otherwise changing the conveyor directions to something other than that depicted in FIG. 5. Furthermore, regardless of the orientation or direction the conveyors are to move, such would still comprise evaluating the impact of controlling each component based on status information associated with other components which would be affected by such control, in particular those components adjacent to the component for which control is being evaluated.

### Control System

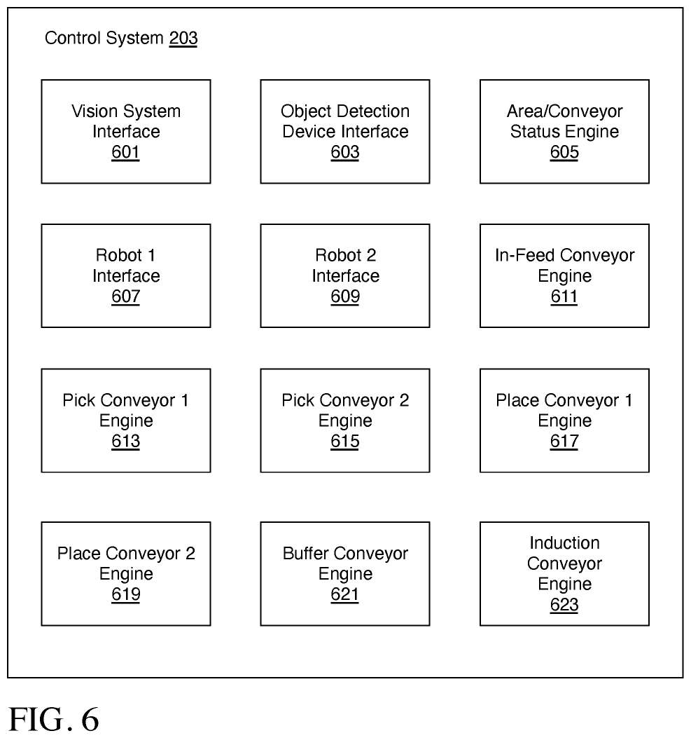

FIG. 6 illustrates an exemplary embodiment of the control system 203. The control system 203 comprises vision system interface 601, object detection device interface 603, area/conveyor status engine 605, first robot interface 607, second robot interface 609, in-feed conveyor engine 611, first pick conveyor engine 613, second pick conveyor engine 615, first place conveyor engine 617, second place conveyor 619, buffer conveyor engine 621, and induction conveyor engine 623. The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Vision system interface 601 is operable to communicate with at least one vision system. Vision system interface 601 may obtain information associated with identified objects for at least one area or conveyor associated with an automated induction system (e.g. automated induction system 300, 400, and/or 500). The obtained information may comprise information indicating at least one of a number of objects in each area, the location of the objects, whether objects are pickable, whether an object was successfully picked and whether an object was successfully placed.

Object detection device interface 603 is operable to communicate with at least one object detection/sensing device. Object detection device interface 603 may obtain information associated with identifying objects associated with at least one area or conveyor associated with an automated induction system. The obtained information may comprise information indicating at least one of the number of objects in a given area, number of objects passing from one area to another, etc.

First robot interface 607 is operable to communicate with a first robot (e.g. robot 404a or 522). Second robot interface 609 is operable to communicate with a second robot (e.g. robot 404b or 532). The robot interfaces 607, 609 are generally operable to obtain information about the status of each robot. Status information for a robot may comprise, but is not limited to, at least one of an indication of ready to pick an object, pick in progress, ready to place an object, place in progress, waiting for pick instructions, in motion, stationary. Such information may aid the below decision engines in determining appropriate actions and the timing of such actions. For example, while a pick is in progress, it may not be ideal to move the corresponding pick conveyor as this could disrupt the robot's ability to successfully pick the object. The same applies on the placement side.

Area/conveyor status engine 605 is operable to determine and/or manage status information associated with at least one area and/or conveyor of an automated induction system (e.g. automated induction system 300, 400, and/or 500). Status engine 605 may determine status information based on input from at least one of vision system interface 601, object detection device interface 603, and robot interfaces 607, 609. For example, status information may comprise at least one of information regarding the presence of objects in a given area, whether a pick operation or place operation is currently underway in a given area, etc. Status engine 605 may employ an indexing approach to manage different statuses for each area/conveyor. For example, a first index value may indicate the presence of an object in an area, a second index value may indicate no object present in an area, a third index value may indicate a pick or place operation is in progress in an area, a fourth index value may indicate a conveyor is currently moving in an area, etc. These are merely exemplary and fewer index values may be used or additional index values may be used to indicate additional statuses as would be apparent to one of ordinary skill in the art. For example, a simplified version may comprise an index value to indicate a “ready” status and another index value to indicate a “not ready” status where the ready/not ready status may be based on the additional information such as whether objects are present and/or whether pick/place operations are in progress. Status engine 605 may maintain and regularly update status information for each of a plurality of different areas within automated induction system as new information is obtained throughout ongoing operations.

In-feed conveyor engine 611 is operable to make decisions regarding control of an in-feed conveyor (e.g. in-feed conveyor 550) and/or generate control instructions or signals for the in-feed conveyor. In-feed conveyor engine 611 may determine controls based on status information associated with at least one other system component such as status information obtained from status engine 605. In one aspect, in-feed conveyor engine 611 determines control based on status information associated with at least one of a first and second pick conveyor. For example, if status information indicates that there is a need for objects in a first and/or second pick area, control signal(s) may be generated to control the in-feed conveyor to introduce new objects to the automated induction system (e.g. to the first pick conveyor 403a or 520).

First pick conveyor engine 613 is operable to make decisions regarding control of a first pick conveyor (e.g. the first pick conveyor 403a or 520) and/or generate control instructions or signals for the first pick conveyor. First pick conveyor engine 613 may determine controls based on status information associated with at least one other system component such as status information obtained from status engine 605. In one aspect, first pick conveyor engine 613 determines control based on status information associated with at least one of in-feed conveyor, first pick area/conveyor (e.g. whether objects are present), first robot, and second pick conveyor/area. Prior to activating first pick conveyor with control instructions/signals it may be necessary to verify adjacent components are prepared for a corresponding action. For example, prior to activating first pick conveyor, it may be necessary to verify at least one of: the second pick conveyor/area is prepared to receive objects moving from the first pick conveyor and that a pick is not currently in progress by the first robot. This is merely one exemplary consideration and first pick conveyor engine 613 may use other information in determining control of first pick conveyor.

Second pick conveyor engine 615 is operable to make decisions regarding control of a second pick conveyor (e.g. second pick conveyor 403b or 530) and/or generate control instructions or signals for the second pick conveyor. Second pick conveyor engine 615 may determine controls based on status information associated with at least one other system component such as status information obtained from status engine 605. In one aspect, second pick conveyor engine 615 determines control based on status information associated with at least one of in-feed conveyor, second robot, second pick conveyor/area (e.g. whether objects are present), and second place area conveyor/area. For example, prior to activating second pick conveyor, it may be necessary to verify at least one of: that there are not pickable objects in the second pick area which would incorrectly be moved into a rejection receptacle and that a pick is not currently in progress by the second robot. This is merely one exemplary consideration and second pick conveyor engine 615 may use other information in determining control of second pick conveyor. In one aspect, second pick conveyor engine 615 may generally drive control operations on the pick side of the automated induction system such that second pick area/conveyor is consistently provided with pickable objects so that second robot incurs minimal downtime waiting to perform its next picking action. This can provide increased throughput by consistently allowing both robots to perform picking operations with less waiting between picks. This, in combination with buffer area/conveyor may further increase throughput by further reducing waiting or downtime associated with robots waiting to execute their next picking operation.

First place conveyor engine 617 is operable to make decisions regarding control of a first place conveyor (e.g. first place conveyor 405a or 524) and/or generate control instructions or signals for the first place conveyor. First place conveyor engine 617 may determine controls based on status information associated with at least one other system component such as status information obtained from status engine 605. In one aspect, first place conveyor engine 617 determines control based on status information associated with at least one of first robot and first buffer area/conveyor. For example, prior to activating first place conveyor, it may be necessary to verify at least one of: the buffer conveyor/area is prepared to receive objects moving from the first place conveyor and that a place operation is not currently in progress by the first robot to place an object on the first place conveyor. This is merely one exemplary consideration and first place conveyor engine 617 may use other information in determining control of first place conveyor.

Second place conveyor 619 is operable to make decisions regarding control of a second place conveyor (e.g. second place conveyor 405b or 534) and/or generate control instructions or signals for the second place conveyor. Second place conveyor engine 619 may determine controls based on status information associated with at least one other system component such as status information obtained from status engine 605. In one aspect, second place conveyor engine 619 determines control based on status information associated with at least one of second robot and induction conveyor. For example, prior to activating second place conveyor, it may be necessary to verify at least one of: the induction conveyor is prepared to receive objects moving from the second place conveyor and that a place operation is not currently in progress by the second robot to place an object on the second place conveyor. This is merely one exemplary consideration and second place conveyor engine 619 may use other information in determining control of second place conveyor.

Buffer conveyor engine 621 is operable to make decisions regarding control of a buffer conveyor (e.g. buffer conveyor 526) and/or generate control instructions or signals for the buffer conveyor. Buffer conveyor engine 621 may determine controls based on status information associated with at least one other system component such as status information obtained from status engine 605. In one aspect, buffer conveyor engine 621 determines control based on status information associated with at least one of second place conveyor/area and second robot. For example, prior to activating buffer conveyor, it may be necessary to verify at least one of: the second place area conveyor is prepared to receive objects moving from the buffer conveyor and that a place operation is not currently in progress by the second robot to place an object on the second place conveyor. This is merely one exemplary consideration and buffer conveyor engine 621 may use other information in determining control of buffer conveyor.

Induction conveyor engine 623 is operable to make decisions regarding control of an induction conveyor (e.g. induction conveyor 540) and/or generate control instructions or signals for the induction conveyor. Induction conveyor engine 623 may determine controls based on status information associated with at least one other system component such as status information obtained from status engine 605. In one aspect, induction conveyor engine 623 determines control based on status information associated with at least second place conveyor. In one aspect, induction conveyor engine 623 determines control information based on an external component such as a downstream induction component indicating an inducted object was returned or rejected in which case the object may be passed in reverse direction back through the induction, place and buffer conveyors to a rejection receptacle (e.g. receptacle 554).

Although described herein with respect to object processing in a downstream fashion (i.e. object flow moving from in-feed conveyor to induction conveyor), additional control considerations may evaluate upstream status information, such as when object flow needs to be reversed due to object rejection or exceptions.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A conveyance system comprising:
an in-feed conveyor for conveying a high density flow of a plurality of parcels;
a first pick conveyor configured for being selectively activated and deactivated in order to space out the plurality of parcels and turn the high density flow into a low density flow of parcels;
a second pick conveyor in series with and downstream of the first pick conveyor;
a first place conveyor;
a second place conveyor in series with and downstream of the first place conveyor;
a first robot configured for transferring parcels from the first pick conveyor to the first place conveyor; and
a second robot configured for transferring parcels from the second pick conveyor to the second place conveyor.

2. The conveyance system of claim 1, wherein the first robot is further configured for avoiding the second pick conveyor and the second place conveyor, and wherein the second robot is further configured for avoiding the first pick conveyor and the first place conveyor.

3. The conveyance system of claim 1, further comprising a buffer place conveyor positioned between the first place conveyor and the second place conveyor such that the buffer place conveyor is in series with the first place conveyor and the second place conveyor, is downstream of the first place conveyor, and is upstream of the second place conveyor.

4. The conveyance system of claim 1, further comprising a first exceptions handling area downstream of the second pick conveyor.

5. The conveyance system of claim 4, further comprising a second exceptions handling area upstream of the first place conveyor.

6. The conveyance system of claim 1, further comprising a vision subsystem comprising a plurality of cameras configured for obtaining images of the parcels in the system.

7. The conveyance system of claim 1, further comprising a plurality of sensors operatively coupled to at least one of: the first pick conveyor, the second pick conveyor, the first place conveyor, and the second place conveyor, wherein the plurality of sensors are configured for detecting whether a part is present.

8. The conveyance system of claim 7, wherein the plurality of sensors comprise line sensors, multi beam sensors, or a combination thereof.

9. The conveyance system of claim 1, further comprising a vision and control system configured for identifying which parcels are exceptions and instructing the first robot and the second robot to avoid the parcels that are identified as exceptions.

10. The conveyance system of claim 5, further comprising a vision and control system configured for determining which parcels are exceptions and instructing the place conveyors to reverse direction until the parcels identified as exceptions are deposited in the second exceptions handling area.

11. The conveyance system of claim 1, further comprising:
a vision system comprising at least one camera configured for obtaining images of items on at least one of the first place conveyor and the second place conveyor; and
a processor configured for processing the images in order to determine placement accuracy.

12. The conveyance system of claim 5, wherein the first place conveyor and the second place conveyor are collinear.

13. The conveyance system of claim 3, wherein the first place conveyor, the second place conveyor, and the buffer place conveyor are collinear.
